(19) United States
(12) Patent Application Publication
(10) Pub. No.: US 2012/0045613 A1
(43) Pub. Date: Feb. 23, 2012

(54) COMPOSITE STRUCTURE

(75) Inventor: Timothy Sanderson, Bristol (GB)

(73) Assignee: AIRBUS OPERATIONS LIMITED, Bristol (GB)

(21) Appl. No.: 13/265,267

(22) PCT Filed: Apr. 15, 2010
(86) PCT No.: PCT/GB10/50627

§ 371 Date: Oct. 19, 2011

(30) Foreign Application Priority Data
Apr. 23, 2009 (GB) 0906953.5

(51) Int. Cl. B32B 7/08; B32B 37/14; B32B 38/04

(52) U.S. Cl. 428/137; 156/253; 156/307.1

(57) ABSTRACT

A structure comprising a cured composite part formed from a series of plies of fibre-reinforced composite material; a doubler plate attached to the composite part by an array of pointed prongs which partially penetrate the composite part; and a hole passing through the doubler plate and the composite part. An interface plate carries the array of prongs on a first side and is attached to the doubler plate on a second side.

### FIELD OF THE INVENTION

The present invention relates to structure with a part formed from a series of plies of fibre-reinforced composite material, and a method of manufacturing such a structure.

### BACKGROUND OF THE INVENTION

A conventional single-lap joint for joining two fibre-reinforced composite parts is shown in FIG. 1. Each part is formed from a series of plies of fibre-reinforced composite material. A hole is drilled through the parts which are then fastened together using a pin 2 (which may be a bolt or rivet). The hole creates weakness in the structure which requires the thickness of each part to be increased locally in the region of the hole. It is not possible to increase the thickness abruptly, since this will tend to cause de-lamination between the plies of material within each part. Therefore the thickness is increased gradually by forming a ramp 3, 4 in each part with an angle of approximately three degrees.

Forming the ramps 3, 4 in the composite parts is a complex and time consuming operation, particularly for a large component such as an aircraft wing cover or spar where a large number of such joints must be formed. Also the ramps 3, 4 add undesirable weight to the joint.

FIG. 2 shows a composite aircraft wing spar 5 with a drilled hole 6. A bracket 7 is attached to one side of the spar, and the other side of the spar is formed with a pair of ramps 8, 9 which increase the spar thickness around the hole 6. The bracket 7 supports a system component (not shown) such as a hydraulic pipe, a bundle of electrical cables, or a fuel inlet pipe which passes through the hole 6 and into the fuel tank.

The structure of FIG. 2 suffers from similar problems to the joint of FIG. 1: that is, forming the ramps 8, 9 in the composite spar is a complex and time consuming operation, particularly for a large aircraft. Also the ramps 8, 9 add undesirable weight to the spar.

### SUMMARY OF THE INVENTION

A first aspect of the invention provides a structure comprising a cured composite part formed from a series of plies of fibre-reinforced composite material; a doubler plate attached to the composite part by an array of pointed prongs which partially penetrate the composite part; and a hole passing through the doubler plate and the composite part.

A second aspect of the invention provides a method of manufacturing a structure, the method comprising:
forming a composite part from a series of plies of fibre-reinforced composite material;
attaching a doubler plate to the composite part by piercing the composite part with an array of pointed prongs which partially penetrate the composite part;
curing the composite part after it has been pierced by the array of prongs; and
forming a hole through the doubler plate and the composite part.

By minimising the need for ramping in the composite part, the invention can provide a weight reduction and increase in manufacturing speed. This is particularly significant for a large component such as an aircraft wing cover or spar where a large number of holes must be formed.

The array of pointed prongs ensures that the bond between the doubler plate and the composite part has high resistance against peel failure.

The hole may be formed by pre-drilling holes in the doubler plate and composite part before they are attached, but more preferably the hole is formed after they are attached.

The prongs may be the tips of pins which pass through the double plate, in the manner of nails passing through a block of wood. However a problem with this arrangement is that the holes formed by the pins may weaken the doubler plate. Therefore more preferably the prongs which pierce the composite part do not also pass through the doubler plate—for instance they may be integrally formed with the doubler plate, or the joint may have an interface plate which carries the array of prongs on a first side and is attached to the doubler plate on a second side. The interface plate may be bonded to the doubler plate by a layer of adhesive, co-cured to the doubler plate or welded to the doubler plate. Alternatively the interface plate may carry a second array of prongs on its second side which either partially or fully penetrate the doubler plate.

Typically the composite part comprises a series of plies of fibre which are impregnated with a matrix; and the prongs and the matrix are formed from different materials.

The doubler plate may consist of metal only, or may be formed from a series of plies of fibre-reinforced composite material. In this case the doubler plate may be formed from a series of plies of fibre impregnated with a thermoplastic matrix material; and the prongs are formed from a thermoplastic material.

The composite part may be formed from a series of plies of “prepreg” composite material, each ply of prepreg comprising a layer of carbon fibres impregnated with a matrix material such as thermosetting epoxy resin. In this case the uncured matrix material is pierced by the prongs. Alternatively the composite part may be laid up as a mat of dry-fibres; the dry-fibres pierced by the prongs; and matrix material subsequently injected into the composite part to impregnate the mat of dry-fibres. In both cases the prongs will typically form a hole by cutting and/or pushing aside material (i.e. fibres and/or matrix) as they pierce the composite part.

The fibres in the composite part may be uni-directional, woven, knitted, braided, stitched, or any other suitable structure.

The composite part is preferably formed from a material which is sufficiently soft to be pierced by the prongs before it is cured. Therefore the composite part may be formed from a thermosetting composite material. Alternatively the composite part may be formed from a thermoplastic composite material, in which case the composite part may need to be heated to make it sufficiently soft to pierce the thermoplastic material, and then cooled to cure the composite material.

The array of prongs may be formed by the so-called “Comeld” process described in EP0626228 or WO2004028731. Alternatively the array of prongs may be grown in a series of layers, each layer being grown by directing energy and/or material from a head to selected parts of a build surface as described in WO2008110835.

The doubler plate may be attached to the composite part by placing the doubler plate carrying the prongs in a recess of a mould tool; laying a series of plies of fibre-reinforced composite material one-by-one onto the mould surface; and pushing the initial plies onto the array of prongs so that the prongs pierce the initial plies. Alternatively the composite part may be laid up, and then the fully assembled composite part joined to the doubler plate by pushing the prongs into the fully assembled composite part. This piercing action may be achieved by moving the prongs, moving the composite part, or a combined motion of both.

The prongs may have a simple triangular profile, or at least one of the prongs may have a transverse cross-sectional area which increases from the tip of the prong to form a pointed head, and then decreases to form an undercut face. The prongs may push aside fibres in the composite material as they pierce the composite part, and then the fibres spring back behind the undercut face. The undercut face can thus increase the pull-through strength of the joint. Alternatively the prongs may cut the fibres as they pierce the composite part.

The hole in the doubler plate and the composite part may be an open hole, or the structure may have a component which passes through the hole in the doubler plate and the composite part. The component may be for instance a hydraulic pipe, a bundle of electrical cables, or a fuel inlet pipe. Alternatively the structure may further comprise a second part, and the component comprises a fastener which passes through the hole in the doubler plate and the composite part, and also passes through the second part. The fastener may be a bolt, rivet or any other suitable fastener.

A further aspect of the invention provides a method of manufacturing a joint with a composite part formed from a series of plies of fibre-reinforced composite material, the method comprising: attaching a doubler plate to an outer face of the composite part by piercing the composite part with an array of pointed prongs which partially penetrate the composite part and curing the composite part after it has been pierced by the array of prongs; overlapping an inner face of a second part with an inner face of the composite part; and passing a fastener through the doubler plate, the composite part, and the second part.

Typically the second part is also formed from a series of plies of fibre-reinforced composite material, and the joint further comprises a second doubler plate attached to an outer face of the second part by an array of prongs which partially penetrate the second part, and the fastener passes through the second doubler plate.

### BRIEF DESCRIPTION OF THE DRAWINGS

Embodiments of the invention will now be described with reference to the accompanying drawings, in which:

FIG. 1 is a sectional view of a conventional single lap joint;

FIG. 2 is a sectional view of part of a spar of an aircraft wing;

FIG. 3 is a perspective view of a lap joint between two composite parts according to a first embodiment of the invention;

FIG. 4 illustrates an additive method of manufacturing the interface plate in the joint of FIG. 3;

FIGS. 5a-5c illustrate a method of attaching the interface plate produced by the method of FIG. 4 to an uncured doubler plate;

FIGS. 6 and 7 show a cured doubler plate, carrying an interface plate for attachment to a composite part, being inserted into a mould tool;

FIG. 8 is a sectional view of a lap joint between two composite parts according to a second embodiment of the invention;

FIG. 9 is a perspective view of a lap joint between two composite parts according to a third embodiment of the invention;

FIG. 10 is a perspective view of a lap joint between two composite parts according to a fourth embodiment of the invention;

FIG. 11 is a close-up sectional view of one of the prongs shown in FIGS. 3, 9 and 10;

FIGS. 12 and 13 are sectional views taken along lines A-A and B-B in FIG. 11. and

FIG. 14 is a sectional view of a structure according to a third embodiment of the invention.

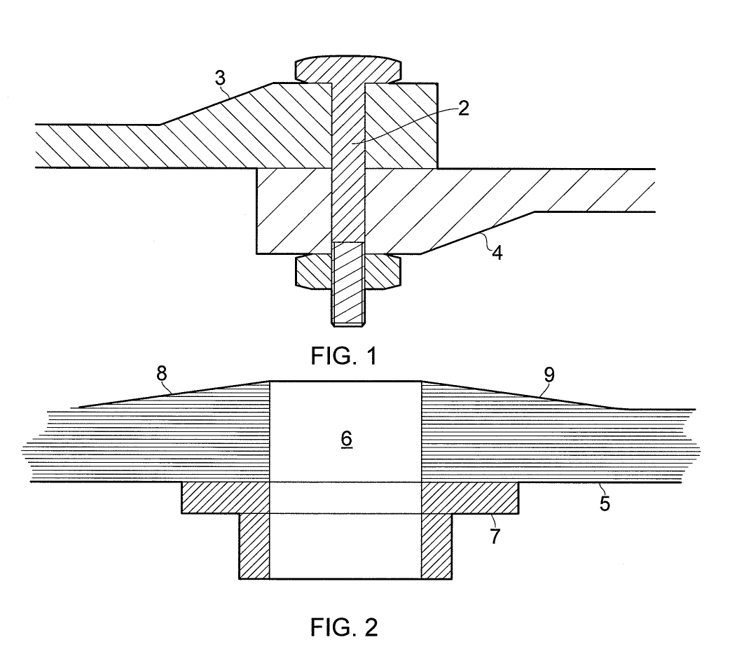

### DETAILED DESCRIPTION OF EMBODIMENT(S)

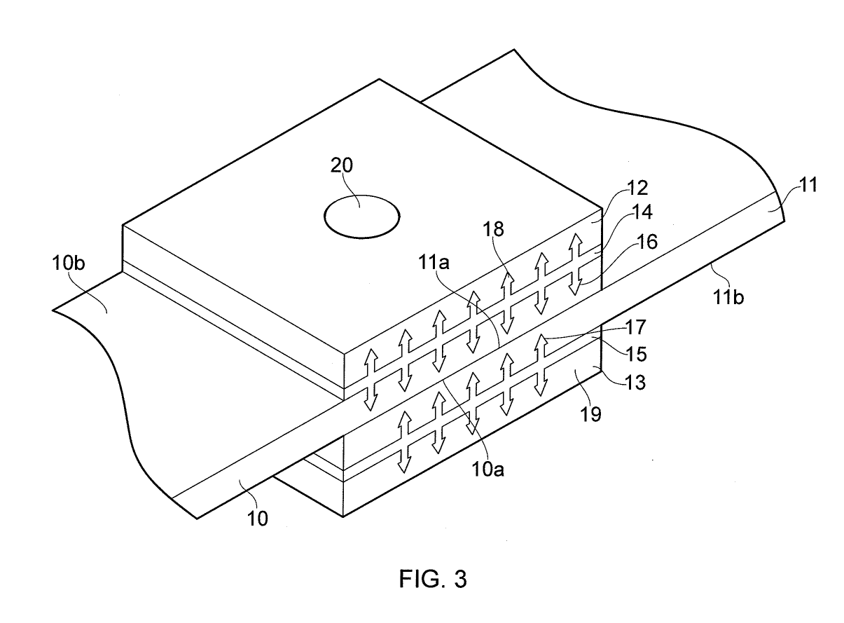

A joint shown in FIG. 3 comprises a first part 10 and a second part 11 each having an inner face 10a, 11a, and an outer face 10b, 11b. Each part is formed from a series of plies of fibre-reinforced composite material. The inner faces 10a, 11a overlap partially to form a single-lap joint. A doubler plate 12, 13 is attached to the outer face of each part by a respective interface plate 14, 15. Each interface plate carries an array of pointed prongs 16, 17 on its inner side which partially penetrates a respective one of the parts 10, 11. Each interface plate also carries an array of pointed prongs 18, 19 on its outer side which partially penetrates a respective one of the doubler plates 12, 13. A hole 20 is drilled through the joint and a fastener (not shown) is passed through the hole 20 to secure the joint.

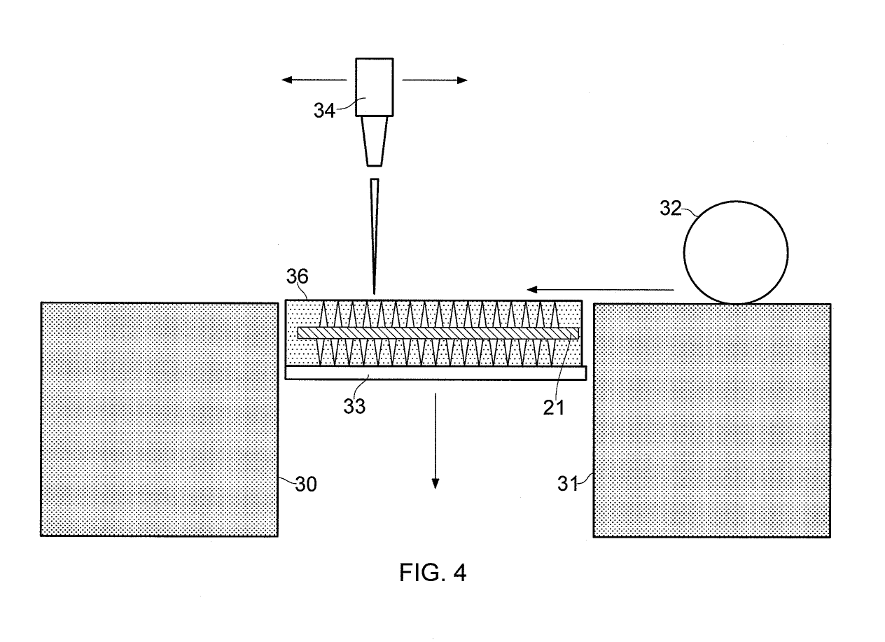

A method of manufacturing a joint similar to the joint of FIG. 3 will now be described with reference to FIGS. 4-8

An interface plate 21 is first manufactured by the powder-bed system illustrated in FIG. 4. The powder bed process shown in FIG. 4 is described in WO2008110835, the contents of which are incorporated herein by reference. The interface plate 21 is formed by scanning a laser head 34 laterally across a powder bed and directing the laser to selected parts of the powder bed. More specifically, the system comprises a pair of feed containers 30, 31 containing powdered metallic material such as powdered titanium. A roller 32 picks up powder from one of the feed containers (in the example of FIG. 4, the roller 32 is picking up powder from the right hand feed container) and rolls a continuous bed of powder over a support member 33. A laser head 34 then scans over the powder bed, and a laser beam from the head is turned on and off to melt the powder in a desired pattern. The support member 33 then moves down by a small distance (typically of the order of 0.1 mm) to prepare for growth of the next layer. After a pause for the melted powder to solidify, the roller 32 proceeds to roll another layer of powder over support member 33 in preparation for sintering. Thus as the process proceeds, a sintered part 21 is constructed, supported by unconsolidated powder parts 36. After the part has been completed, it is removed from support member 33 and the unconsolidated powder 36 is recycled before being returned to the feed containers 30, 31.

The powder bed system of FIG. 4 can be used to construct the entire interface plate (including the prongs) as a single piece. Movement of the laser head 34 and modulation of the laser beam is determined by a Computer Aided Design (CAD) model of the desired profile and layout of the part.

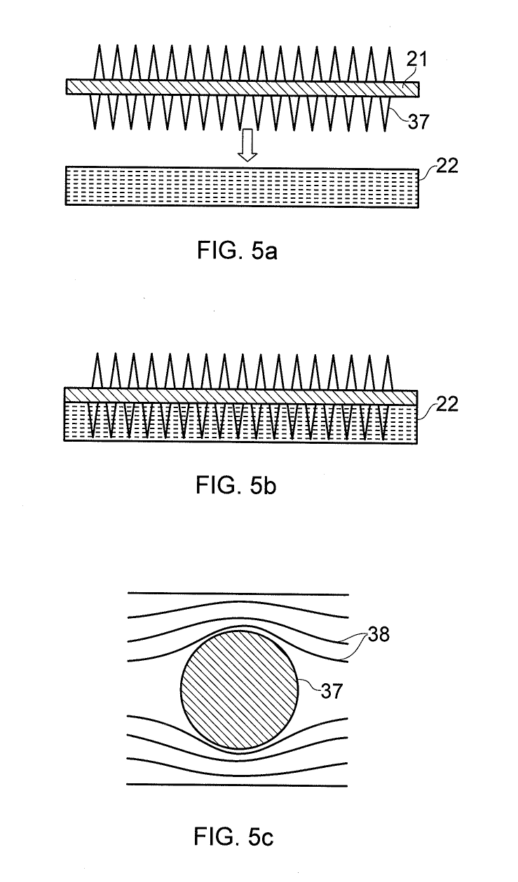

Next, referring to FIG. 5a, a stack of plies 22 of uncured “prepreg” composite material is laid up. Each ply of prepreg comprises a layer of unidirectional carbon fibres impregnated with a thermosetting epoxy resin matrix.

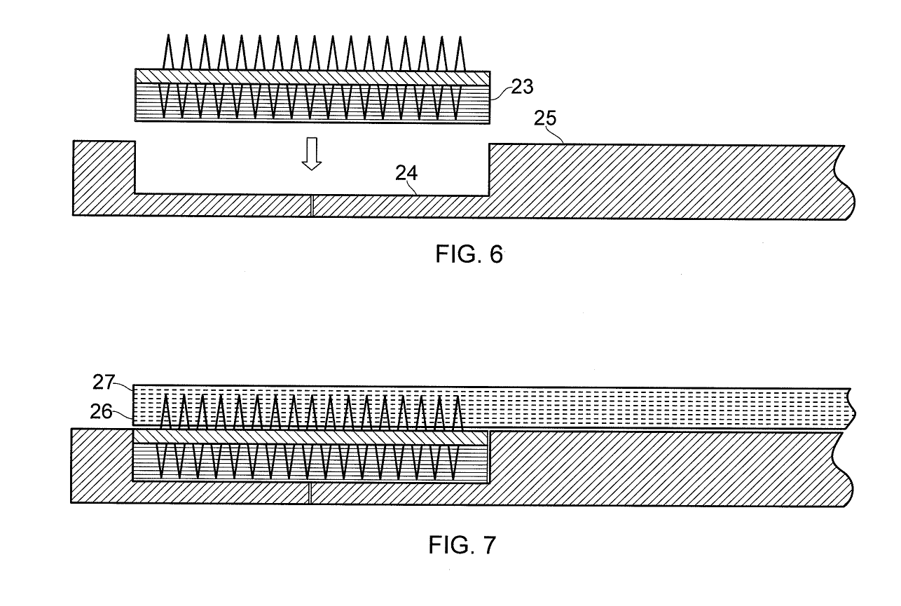

The interface plate 21 is then attached to the inner face of the uncured stack 22 by pushing the array of pointed prongs on the underside of the interface plate into the uncured stack 22 as shown in FIG. 5a. The uncured epoxy resin is soft and therefore relatively easy to pierce with the prongs. Note that the length of the prongs is less than the thickness of the prepreg stack so the doubler plate is only partially penetrated by them. The stack is then cured by heating to approximately 180° C. to form a cured doubler plate 23 shown in FIG. 6.

FIG. 5c is a transverse cross-sectional view taken across one of the prongs 37 in FIG. 5b parallel with the plane of the stack 22. As shown in FIG. 5c, the prong 37 pushes aside fibres 38 in the composite material as it pierces the stack.

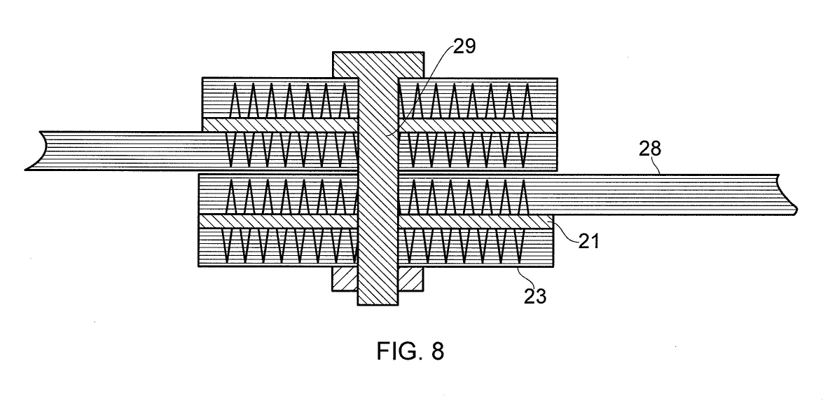

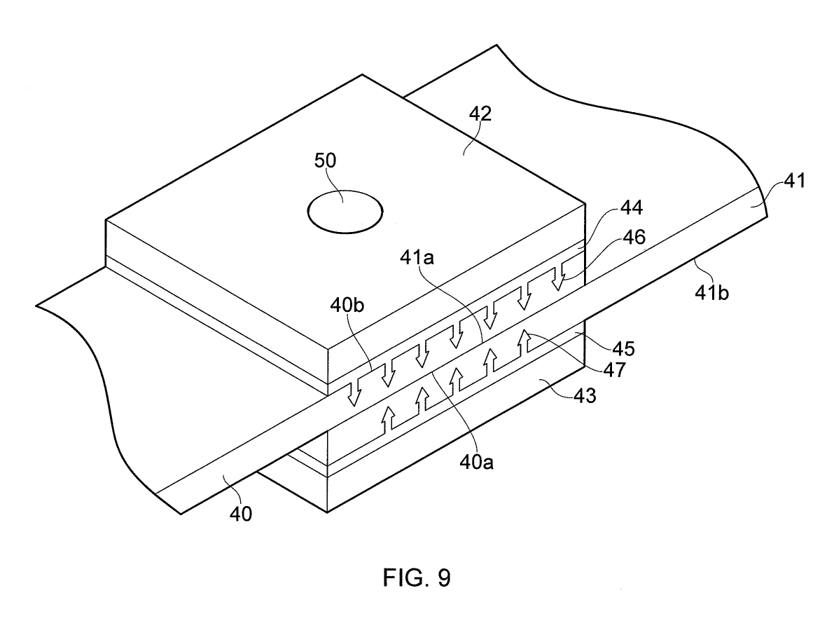

Next the cured doubler plate 23 carrying the interface plate 21 is placed in a recess 24 of a mould tool as shown in FIG. 6. A series of prepreg plies is then laid one-by-one onto the mould surface 25 of the mould tool. The lower layers 26 of prepreg are pushed onto the array of upwardly directed prongs so that the prongs pierce the prepreg. The prepreg is then pushed down fully until it engages the preceding layer. Note that the length of the prongs is less than the thickness of the prepreg stack so the upper prepreg layers 27 are not pierced. That is, the prongs only partially penetrate the prepreg stack so that the tips of the prongs are embedded within the stack. The stack is then cured by heating to approximately 180° C. to form a cured part 28 shown in FIG. 8.

Note that the doubler plate 23 may be attached to the interface plate 21 by the process of FIG. 7 if required.

Finally the assembly 21, 23, 28 is overlapped with a similar assembly as shown in FIG. 8; a hole is drilled through the joint; and a fastener pin 29 is passed through the hole to secure the joint.

The use of a relatively thin metal interface plate 21 minimises distortion caused by differential thermal expansion between the interface plate 21 and the composite parts 23, 28.

A joint shown in FIG. 9 comprises a first part 40 and a second part 41 each having an inner face 40a, 41a, and an outer face 40b, 41b. The inner faces 40a, 41a overlap partially to form a single-lap joint. A doubler plate 42, 43 is attached to the outer face of each part by a respective interface plate 44, 45. Each interface plate carries an array of pointed prongs 46, 47 on its inner side which partially penetrates a respective one of the parts 40, 41. A hole 50 is drilled through the joint and a fastener (not shown) is passed through the hole 50 to secure the joint.

Each doubler plate 42, 43 is formed from a stack of plies of composite material. Each ply comprises a layer of carbon fibres impregnated with a thermoplastic matrix material such as polyetheretherketone (PEEK). The doubler plates 42, 43 are placed on the support member 33 of the powder bed system of FIG. 4, and the interface plates 44, 45 are built up on top of the doubler plates by the powder bed process described above, but using powdered PEEK in the hoppers 30,31 instead of titanium. Note that the thermoplastic surface of the doubler plate is melted by the laser beam along with the first layer of PEEK powder, thus forming a secure bond between the doubler plates and the interface plates.

In contrast with the thermoplastic doubler plates 42, 43, the parts 40, 41 are formed from thermosetting prepreg, similar to the parts 10, 11. The parts 40, 41 can be laid up onto the doubler plates 42, 43 in a mould tool recess using the process shown in FIG. 7.

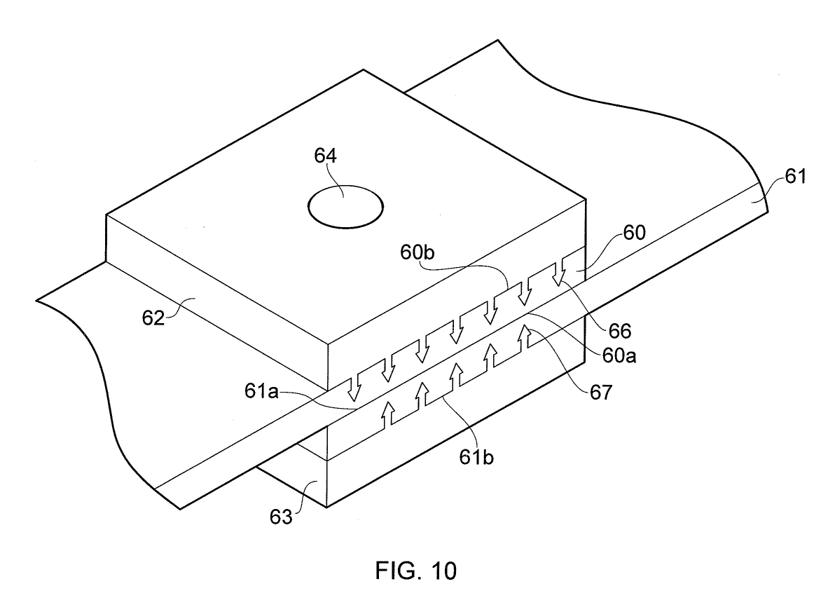

A joint shown in FIG. 10 comprises a first composite part 60 and a second composite part 61 each having an inner face 60a, 61a, and an outer face 60b, 61b. The inner faces 60a, 61a overlap partially to form a single-lap joint. A doubler plate 62, 63 is attached to the outer face of each part. Each doubler plate carries an array of integrally formed pointed prongs 66, 67 on its inner side which partially penetrates a respective one of the parts 60, 61. A hole 64 is drilled through the joint and a fastener (not shown) is passed through the hole 64 to secure the joint.

The doubler plates 62, 63 and prongs 66, 67 are formed together as a single piece using the powder bed process shown in FIG. 4. The doubler plates and prongs can be formed from titanium or any other suitable material. The parts 60, 61 are formed from thermosetting prepreg, similar to the parts 10, 11. The parts 40, 41 can be laid up onto the doubler plates 62, 63 in a mould tool recess using the process shown in FIG. 7.

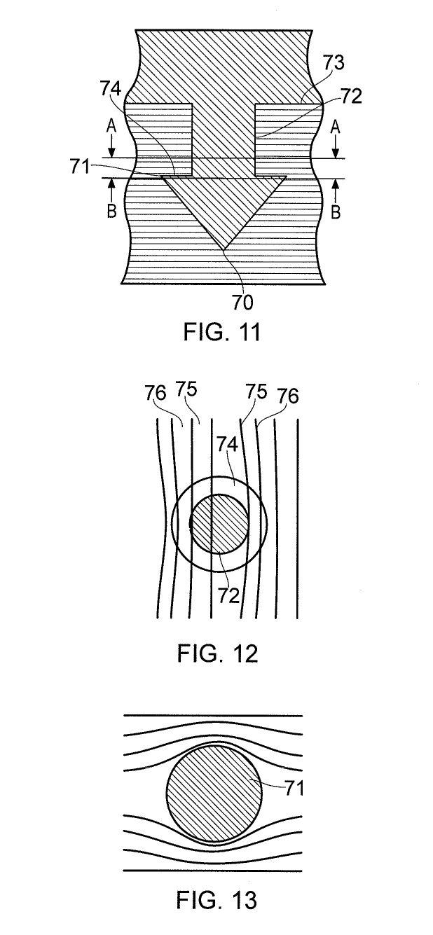

One of the prongs shown in FIGS. 3, 9 and 10 is shown in longitudinal section in FIG. 11. The prong has a pointed head which tapers outwardly from a tip 70 to a base 71; and a shaft 72 which joins the head to the face 73. The transverse cross-sectional area of the prong measured parallel with the face 73 increases from the tip 70 to a maximum at the base 71 of the head. The transverse cross-sectional area then decreases to form an undercut face 74.

As shown in FIGS. 12 and 13, as the prong is pushed into the composite material the fibres are pushed apart by the tapered head and then spring back behind the base 71 of the tapered head to engage the shaft 72. The fibres 75, 76 which have sprung back engage the undercut face 74 and thus increase the pull-through strength and peel resistance of the bond.

Note that the fibre behaviour shown in FIGS. 12 and 13 is idealised, and a certain number of the fibres may also be cut or snapped by the piercing action of the pointed head.

Note that the fibres in each layer will typically extend in different directions, so by way of example the fibres in FIG. 12 are shown at right angles to the fibres in FIG. 13.

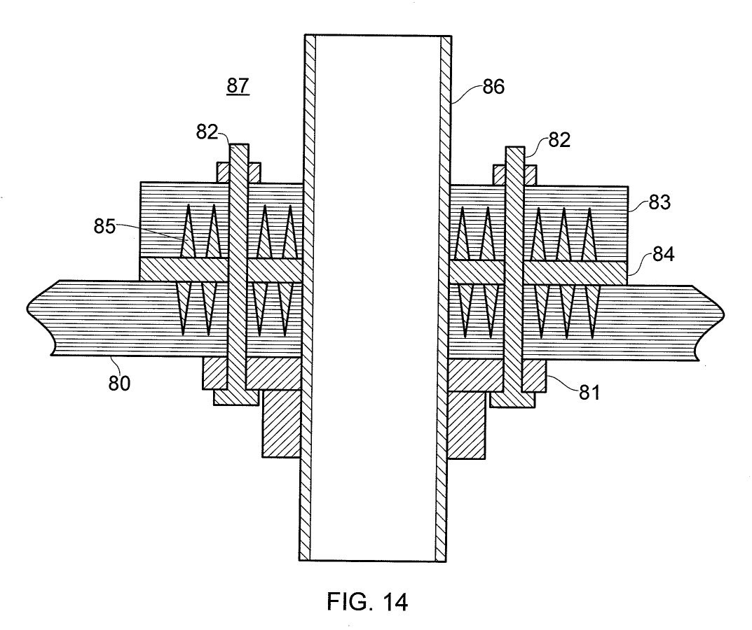

FIG. 14 is a sectional view of a structure according to a third embodiment of the invention. FIG. 14 shows a composite front spar 80 for an aircraft wing. A bracket 81 is attached to the forward side of the spar by bolts 82. A composite doubler plate 83 is attached to the spar by an interface plate 84 with an array of pointed prongs 85 which partially penetrate the spar 80. A hole is drilled through the spar 80 and the doubler plate, and a hydraulic pipe 86 passed through the hole into the fuel tank 87 on the aft side of the spar. The pipe 86 is supported by the bracket 81. A similar arrangement may be used to pass electrical cables or other systems through the front spar and into the fuel tank.

Although the invention has been described above with reference to one or more preferred embodiments, it will be appreciated that various changes or modifications may be made without departing from the scope of the invention as defined in the appended claims.

1. A structure comprising a cured composite part formed from a series of plies of fibre-reinforced composite material; a doubler plate attached to the composite part by an array of pointed prongs which partially penetrate the composite part; and a hole passing through the doubler plate and the composite part.

2. The structure of claim 1 further comprising an interface plate which carries the array of prongs on a first side and is attached to the doubler plate on a second side.

3. The structure of claim 2 wherein the interface plate carries a second array of pointed prongs on its second side which partially or fully penetrate the doubler plate.

4. The structure of claim 1 wherein the doubler plate is formed from a series of plies of fibre-reinforced composite material.

5. The structure of claim 1 wherein at least one of the prongs has a transverse cross-sectional area which increases from the tip of the prong to form a pointed head, and then decreases to form an undercut face.

6. The structure of claim 1 wherein the composite part is formed from a thermosetting composite material.

7. The structure of claim 1 further comprising a component which passes through the hole in the doubler plate and the composite part.

8. The structure of claim 7 further comprising a second part, wherein the component comprises a fastener which passes through the hole in the doubler plate and the composite part, and also passes through the second part.

9. The structure of claim 8 wherein the second part is formed from a series of plies of fibre-reinforced composite material, the structure further comprises a second doubler plate attached to the second part by an array of prongs which partially penetrate the second part, and the fastener passes through the second doubler plate.

10. The structure of claim 1 wherein the prongs which pierce the composite part do not pass through the doubler plate.

11. A method of manufacturing a structure, the method comprising:
forming a composite part from a series of plies of fibre-reinforced composite material;
attaching a doubler plate to the composite part by piercing the composite part with an array of pointed prongs which partially penetrate the composite part;
curing the composite part after it has been pierced by the array of prongs; and
forming a hole through the doubler plate and the composite part.

12. The method of claim 11 further comprising growing the array of prongs in a series of layers, each layer being grown by directing energy and/or material from a head to selected parts of a build surface.

13. The method of claim 11 wherein the prongs form holes in the composite part as they pierce it.

14. The method of claim 10 wherein the prongs attach the doubler plate to the composite part without piercing the doubler plate.

15. The method of claim 10 wherein the doubler plate is attached to the composite part by placing the doubler plate carrying the prongs in a recess of a mould tool; laying a series of plies of fibre-reinforced composite material one-by-one onto the mould surface; and pushing the initial plies onto the array of prongs so that the prongs pierce the initial plies.
